(19) United States
(12) Patent Application Publication
(10) Pub. No.: US 2005/0029826 A1
(43) Pub. Date: Feb. 10, 2005

(54) Release hook

(76) Inventor: Calum John Mackinnon, Aberdeen (GB)

Correspondence Address: Fleshner & Kim, Suite 1100, 2325 Dulles Corner Boulevard, Herndon, VA, 22171, US

(21) Appl. No.: 10/501,138

(22) PCT Filed: Jan. 24, 2003
(86) PCT No.: PCT/GB03/00250

(30) Foreign Application Priority Data
Jan. 24, 2002 (GB) 0201584.0

(51) Int. Cl. B66C 1/34

(52) U.S. Cl. 294/82.3

(57) ABSTRACT

A release hook (10) for selectively releasing a load supported on the hook (10). The hook (10) includes an ejector lever (28) which is actuated by a motor (42) and gearing mechanism (38) located within the hook (10). This arrangement provides a relatively lightweight and compact hook (10). Embodiments of gearing mechanisms (38) are described as is a catch to hold (36) a cable (20) or the like in the hook (10) and various pad-eyes (16) which advantageously swivel to allow the hook (10) to rotate relative to a crane block.

The present invention relates to hooks used on cranes and lifts and in particular, although not exclusively, to a hook that selectively releases a load being supported by the hook.

It has been recognised in the prior art that for many environments such as offshore oil and gas exploration, the use of an automated release mechanism for a hook can be advantageous. In particular, this allows the operator to be remote from the hook when the load is released providing for a safer working environment.

The original hooks which incorporated release mechanisms automatically released when the load reached the ground and the cable tension slackened. Unfortunately, a disadvantage of these systems is that the load can only be released when it is set down and also, if the load is placed in the wrong position it has to be manually placed back upon the hook for it to be moved again.

A remotely controlled crane hook which provides for selective ejection of a load from a hook, is proposed in

GB Patent Application No 2,293,497. In this hook a sliding ejector lever is used under the cable or guide ropes. To operate the hook, a hydraulic ram moves the ejector lever up, thereby ejecting the guide ropes over a retaining edge of the hook. Though this hook has the advantage that it can be remotely operated to allow the crane operator to be distant from the hook whilst selectively choosing when the load is released, it has a major disadvantage in its size and weight. To operate the ejector it requires a housing including a motor, a hydraulic pump driven by the motor, a power supply for the motor, a hydraulic ram driven by the hydraulic pump together with the necessary control circuitry for remote operation. Such a hook including these components is typically one metre in length and one metre in diameter with a weight of around 500 kg. As this hook is so large and heavy it is difficult for a crane operator to manoeuvre the hook to attach a load. A further disadvantage of this hook is that it is welded together to form a one piece body containing the ejector lever. Such an arrangement prevents the hook being disassembled for repair.

One hook which overcomes these disadvantages is described in International Patent Application No WO98/37009. This Application discloses a release mechanism within a hook for use in supporting a load from a crane. The hook is again remotely operable and the load is released by an identical ejector lever mechanism operated by the standard hydraulic ram. The advantage of this system is that the power and control means for the hydraulic ram is located in a housing connected to the hook via a support link. While this reduces the weight on the hook, making the hook more manageable for an operator, this system has the disadvantage that the hook including the power control housing is approximately 6 metres in length. The connections via the support link between the housing and the hook prevent the hook from independently swivelling and thus the full length and weight of the combination must by manoeuvred to swivel the hook to the correct direction for connecting a cable onto the hook.

It is an object of the present invention to provide a hook for use in supporting a load from a crane, which obviates or mitigates one or more disadvantages of the prior art.

It is a further object of the present invention to provide a hook for use in supporting a load from a crane, the hook being capable of selectively releasing the load by an ejector lever, the ejector lever not being operated by hydraulic means. By removing the hydraulic means to operate the ejector lever, the weight and dimensions of the hook can be reduced to make a more lightweight and compact hook, which is more manoeuvrable and safer to operate.

It is a further object of the present invention to provide a hook for use in supporting a load from a crane, the hook being capable of selectively releasing the load by an ejector lever, the ejector lever being operated by a motor and gearing means located within the hook.

It is an object of at least one embodiment of the present invention to provide a hook for use in supporting a load from a crane, the hook being capable of selectively releasing the load by an ejector lever operated via remote control.

According to a first aspect of the present invention, there is provided a release hook for selectively releasing a load supported on the hook, the hook including an ejector lever for releasing the load from the hook upon actuation of the ejector lever wherein actuation of the ejector lever is provided by a motor and gearing means located adjacent the ejector lever.

As the motor and gears take up less space than the hydraulic ram and its associated power supplies, the hook is therefore lightweight and the gearing means and motor can be housed within a hook of relatively small dimensions and weight.

Preferably, the motor is remotely operated. More preferably the remote operation is by a wireless telemetry system as is known in the art. Preferably, the motor is an electric motor driven from a battery housed in the hook.

Preferably, the hook comprises a housing having two interconnected generally ‘C’ shaped sections with the ejector lever being located at a base of the ‘C’ between the sections. The sections may be bolted together. Preferably, also the hook includes a catch. The catch may be located across an opening of the hook where the cable carrying the load is inserted. The catch may comprise an elongate member attached to the ejector lever. The catch prevents the cable being prematurely ejected when the hook is moved. Thus, the catch actively retains the cable within the hook.

Advantageously the catch may integral with the ejector lever, the catch and ejector lever being oppositely opposed on a pivot. In this arrangement the catch will swing away from the hook when the ejector is actuated. The catch can then be used to guide a cable, ring or the like onto the hook as the ejector lever is moved to its deactivated position. Thus for safety, the cable, ring or the like can be mounted on the hook without the need for personnel to enter the area around the hook.

Preferably, the gearing means comprises a rack and pinion, the pinion being operable via the motor. The rack is preferably located on the ejector lever. In this manner, rotation of the motor causes mutual engagement of teeth in the pinion with teeth on the rack and consequently the ejector lever is moved linearly in relation to the rotating pinion of the motor. Most preferably, this linear motion is vertical on the hook, raising the ejector lever towards the opening.

Alternatively, the gearing means may comprise a worm gear. In this arrangement the motor will turn the worm whose screw thread is located against matching notches on an edge of the ejector lever. Thus, operation of the motor allows the ejector lever to be raised or lowered along the linear axis of the worm. This gearing means has the additional advantage that the motor need only turn a small amount to provide a significant distance change on the ejector lever.

Preferably the gearing means may comprise a drive sprocket, driven by the motor to rotate the ejector lever on a pivot. Preferably also the gearing means rotates the catch with the ejector lever.

Preferably also, the hook includes a pad-eye which may be referred to as a clevis. The pad-eye provides the contact between the hook and a crane. In one embodiment of the present invention the pad-eye includes an eye-let aperture such that a link may be made between the pad-eye and a crane block of the crane. In a further embodiment of the present invention the pad-eye comprises a shaft including connection means to a crane block. Preferably the connection means is a screw thread on the shaft and a matching threaded recess in the crane block. Thus, the hook may be located at or within the crane block.

Advantageously the pad-eye is swivel mounted on a top of the hook. The pad-eye may include a base of greater diameter than the shaft, such that the base is retained between the two sections of the housing while remaining rotatable with respect to the housing.

Preferably the hook has dimensions of less than 17.05×9.86×3 inches in height, width and depth respectively. Preferably also the hook has a weight of approximately 12 to 16 kg. Preferably the hook is made of steel or the like. Advantageously the hook provides a 12 tonne lift.

Embodiments of the present invention will now be described by way of example only with reference to the following drawings which:

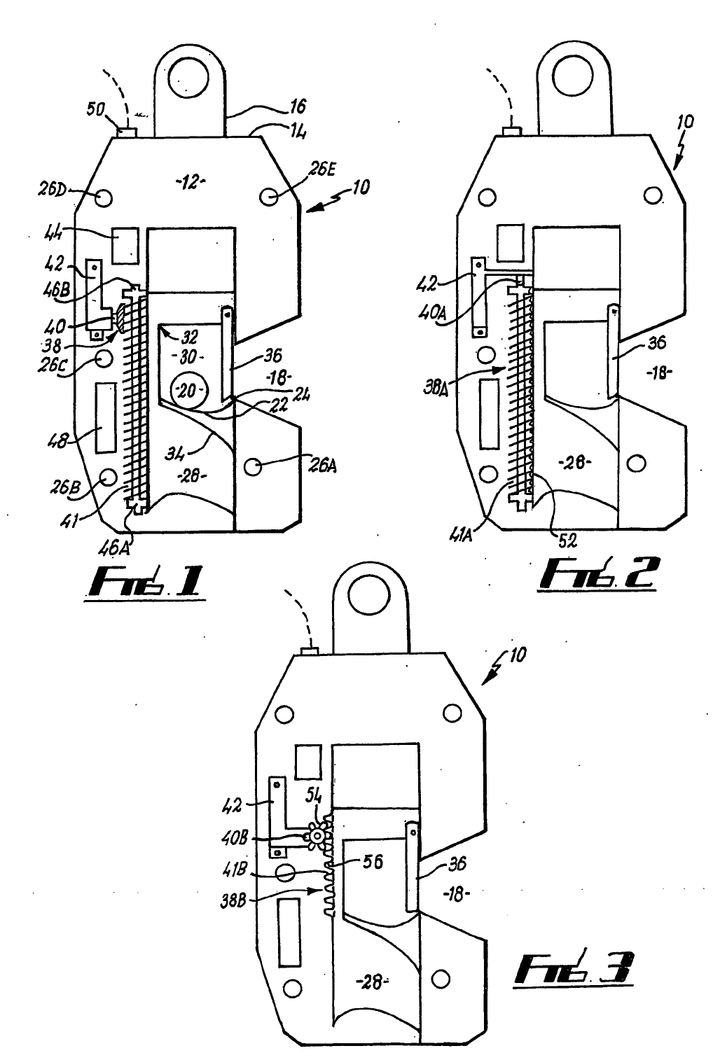

FIG. 1 is a cross-sectional schematic view of a release hook according to the present invention;

FIG. 2 is a cross-sectional schematic view of a release hook including a gearing means according to a first embodiment of the present invention;

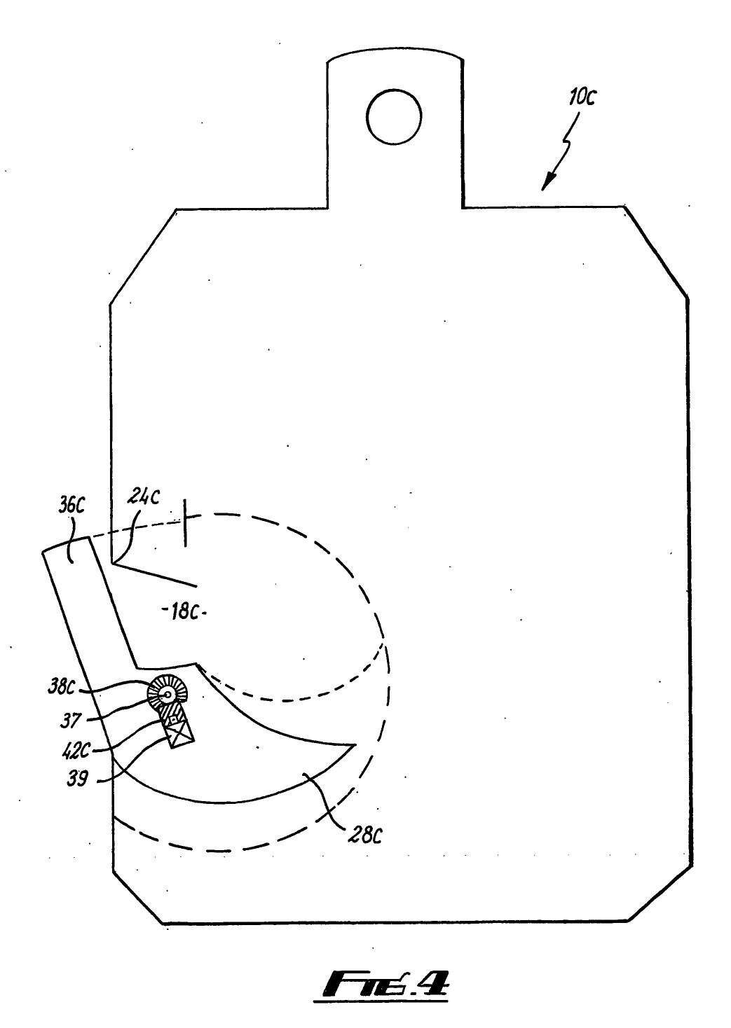

FIG. 3 is a cross-sectional schematic view of a release hook including a gearing means according to a second embodiment of the present invention;

FIG. 4 is a cross-sectional schematic view of a release hook according to a further embodiment of the present invention;

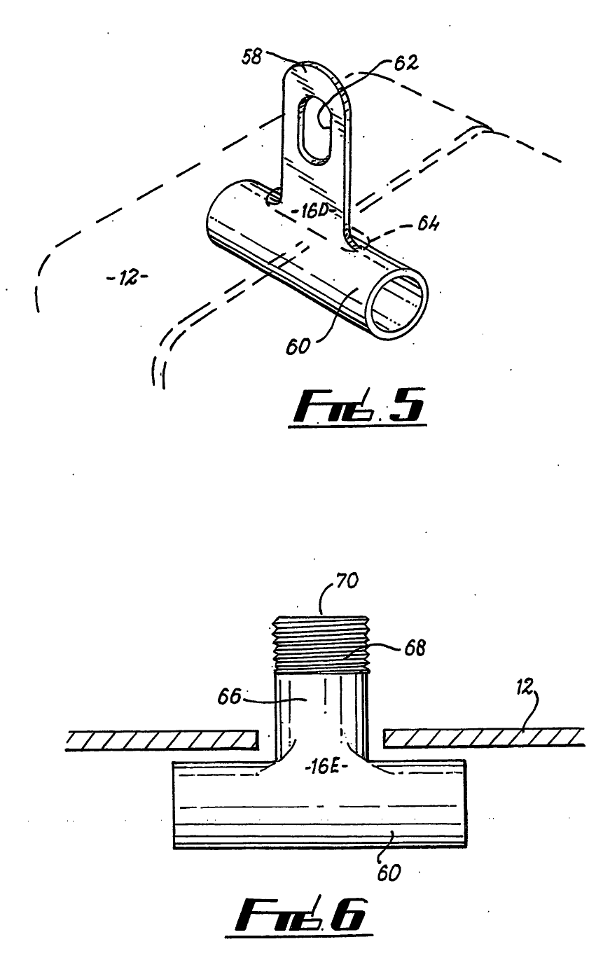

FIG. 5 is a cross-sectional view of a pad-eye of a hook according to an embodiment of the present invention; and

FIG. 6 is a schematic plan view of a pad-eye of a hook according to a further embodiment of the present invention.

Reference is initially made to FIG. 1 of the drawings which illustrates a release hook, generally indicated by reference numeral 10, according to the present invention, a hook 10 comprises a body 12 having a top surface 14 where a pad-eye 16 is located. Pad-eye 16 will be described hereinafter. As is known in the art, pad-eyes are used for making a connection between the hook 10 and a crane block (not shown).

Body 12 has a generally “C” shaped structure, there being an opening 18 through which a cable 20 may be inserted.

Within the body is a recess 22 formed past the opening over a lip 24. The lip 24 helps maintain the cable 20 within recess 22. It will be appreciated that cable 20 may represent any load positioned on the hook 10 to be lifted; Body 12 generally comprises 2 ‘C’ shaped sections bolted together via bolts 26A-E. These bolts 26A-E allow the body 12 to be disassembled so that access can be made to the parts therein.

Located between the body sections is an ejector lever 28. Ejector lever 28 has a generally rectangular shape from which is cut a section 30. Section 30 has a right-angled corner portion 32 and a sloping surface 34. The ejector lever 28 may be referred to as a guillotine such that when moved upwards towards the pad-eye 16, the cable 20 will be inclined to travel down the slope 34 and out of opening 18.

Attached to ejector lever 28, is a catch 36. The catch 36 provides a closing portion over recess 22. The catch 36 is an elongate member having a length equal to or greater than the opening 18. The catch 36 acts as a safety mechanism in the event that the hook 10 is moved substantially during lifting, thus preventing cable 20 from exiting the recess 22 until selectively requested to do so.

At a side of ejector lever 28 is a gearing arrangement 38. The gearing arrangement 38 is driven from spindle 40. This arrangement of gears ensures that when spindle 40 is turned, the gears operate the ejector lever 28 and thereby move the ejector lever in a linear motion vertically upwards or downwards towards or away from the pad-eye 16. The spindle 40 is controlled from an electric motor 42. The electric motor 42 is powered from a battery 44. It will be appreciated that the battery may be of any replaceable form and in the embodiment shown the battery is a 12-volt dry cell battery. The motor 42 has a right-angled motor drive which is attached to the spindle 40, being a Teflon (Trade Mark) gear which moves the ejector lever up and down on a worm, or gear 41. The gear 41 is fixed to the ejector lever 28, by brass bushels 46A,B.

The ejector lever 28 is remotely controlled. This is achieved through a telemetry system 48, housed within the body 12. A remote panel (not shown) is operated by a crane operator at a remote distance from the hook 10. Signals from the remote panel are transmitted and received via the antenna 50 located at the top 14 of the hook 10. The signals are relayed to the telemetry system 48. This in turn controls the motor 42 and consequently, the gearing means 38 for movement of the ejector lever 28.

When constructed, the hook 10 has general dimensions of height less than 20 inches, width less than 10 inches and a depth less than 3 inches. In a preferred embodiment the height is 17.05 inches, width is 9.86 inches and the depth is 3 inches. In a further embodiment of the present invention, a compact hook 10 has dimensions, height 14 inches, width 8 inches and depth 2.25 inches.

The weight of the hook is approximately 12 to 16 kilograms depending on the material of construction. In the preferred embodiment the material is steel however it will be appreciated that many other materials and alloys thereof can be used. The hook 10 can provide a 12 tonne lift.

In use, hook 10 is mounted on a support link (not shown) via pad-eye 16 to a crane block(not shown) of a crane. An operator pushes a cable 20, chain or the like onto the hook via opening 18 and by operation of the catch 36 the cable 20 is secured within recess 22. The load connected to the cable 20 may now be lifted by the hook 10 and moved by the crane. When the load is in the correct position, or it is determined that the load should be ejected from the hook, the operator provides a signal via their control panel located remotely from the hook 10. The signal is transmitted through antenna 50 to the telemetry system 48. System 48 transmits a signal to start the motor 42 which is powered from the 12 volt battery 44. The motor 42 drives spindle 40 whose rotation causes the gearing 38 to be moved and thereby the ejector lever 28 is moved vertically towards the pad-eye 16. As the ejector lever 28 moves, cable 20 engages with the sloping surface 34. At the same time, catch 36 is moved away from opening 18 and consequently, cable 20 is ejected through opening 18 in a guillotine like motion. The load is then separate from the hook and the ejector lever can be signalled to relocate into the recess.

Reference is now made to FIG. 2 of the drawings, which illustrates a hook 10, having a gearing arrangement 38A according to a first embodiment of the present invention. Identical parts to those of FIG. 1 have been given the same reference numeral while like parts are given the same reference numeral but are now suffixed ‘A’. In this embodiment motor 42 drives a spindle 40A which is now mounted linearly to worm 41A. Thus spindle 40A turns worm 41A. Worm 41A engages with teeth 52, which are mounted on a side of the ejector lever 28. In this embodiment the ejector lever 28 is moved vertically by the engagement of the teeth 52 with the worm 41A.

A further gearing arrangement according to a second embodiment of the present invention is illustrated in FIG. 3. Again, identical parts to those of FIG. 1 have been given the same reference numeral while like parts are given the same reference numeral but are now suffixed ‘B’. In this embodiment the gearing arrangement 38B is a rack and pinion system. Spindle 40B, the pinion, is attached to motor 42. As spindle 40 rotates, teeth 54 engage with similar teeth 56 on the rack 41B located on the side of the ejector lever 28. It will be appreciated that the spindle 40B may be rotated in either direction to move the ejector lever 28 upwards or downwards as required. Additionally the spindle 40B may be mounted at right angles to the motor so that teeth 54 are perpendicular to teeth 56.

Reference is now made to FIG. 4 of the drawings which illustrates a release hook, generally indicated by reference numeral 10C, according to an embodiment of the present invention. Like parts to those of FIGS. 1 to 3 have been given the same reference numeral but are now suffixed ‘C’. In this embodiment, catch 36C and ejector lever 28C are of single piece construction. They are mounted on a pivot 37 on which they can rotate. Rotation is provided from a drive sprocket 38C on which the motor 42C is mounted. An associated gear box 39 is also provided. The motor 42C is operated remotely as hereindescribed with reference to the earlier Figures. In use, hook 10C, via the catch 36C guides a cable, link or the like (not shown) into the opening 18C. This is achieved by rotating the catch 36C and lever 28C on the pivot 37, in a clockwise direction by use of the motor 42C. Catch 36C will then meet lip 24C and formed a closed area in which the cable is held. When the cable requires to be released, the catch 36C and lever 28C are rotated on the pivot 37, in an anti-clockwise direction. Catch 36C moves away from the hook 10C, ejector lever 28C pushes the cable along the surface 34C and when the ejector lever 28C reaches the lip 24C the cable will fall from the hook 10C. As the catch 36C is used as a guide, the cable is less likely to become snagged and additionally does not require someone to mount the cable on the hook. Thus this embodiment provides automatic loading for the hook.

It will be appreciated by those skilled in the art that a double cam may have to be incorporated with the drive sprocket in order to achieve rotation in both a clockwise and anti-clockwise direction of the catch 36C and ejector lever 28C.

Reference is now made to FIG. 5 of the drawings which illustrates a pad-eye of the hook according to an embodiment of the present invention. Pad-eye 16D comprises a one piece body having a shaft 58 and a base 60. The base 60 may be of any shape provided that it is retained within the body 12 of the hook 10 and the body 12 can swivel freely through 360 degrees on the pad-eye 16D. In the embodiment shown the shaft 58 and base 60 are ‘T’ shaped. Shaft 58 includes an aperture 62 through which a connection can be made. Aperture 62 is cylindrical having rounded edges to prevent rubbing on cables or connectors. In use, pad-eye 16D is mounted between the two sections of the body 12 and the shaft 58 is located though an aperture 64 formed at the join between the sections of the body 12.

Reference is now made to FIG. 6 of the drawings which illustrates a pad-eye according to a further embodiment of the present invention. Pad-eye 16E is identical to pad-eye 16D of FIG. 5 except for the shaft. The shaft 66 of this embodiment has no aperture. Shaft 66 includes a threaded portion 68 at a distal end 70 of the shaft 66. In use, pad-eye 16E is located into the body 12 of the hook 10 in an identical manner to that of pad-eye 16D while the threaded portion 68 is screwed into a threaded hole located in a crane block. This embodiment offers the advantage of taking the crane block out of the work area.

A principal advantage of the present invention is that it provides a lightweight and compact release hook compared to the prior art. This is achieved by removing the requirement of having a hydraulic ram with the associated pump and drive means generally needed with such release hooks.

A further advantage of the present invention is that the hook is composed of detachable parts, so that access can be given to the internal workings for replacement and repair. For example, battery 44 will need to be replaced or recharged at intervals.

A yet further advantage of an embodiment of the present invention is that a catch can be provided which both guides a cable, link or the like onto the hook and retains it on the hook until ejected.

It will be appreciated by those skilled in the art, that further modifications may be made to the invention as described herewith without departing from the scope thereof. For example, alternative gearing arrangements driven from a motor could be used. Equally, the motor could be driven by a different power source than battery as long as they do not require any external connections to the hook which would prevent the hook from swivelling freely.

1. A release hook for selectively releasing a load supported on the hook, the hook including a pad-eye for connecting the hook to a crane and an ejector lever for releasing the load from the hook upon actuation of the ejector lever characterised in that actuation of the ejector level is provided by a motor and gearing means located adjacent the ejector lever which move the ejector lever upwards towards the pad-eye to eject the load.

2. A release hook as claimed in claim 1 wherein the motor is remotely operated.

3. A release hook as claimed in claim 1 wherein the motor is an electric motor driven from a battery located in the hook.

4. A release hook as claimed in any claim 1, wherein the hook comprises a housing having two interconnected generally ‘C’ shaped sections with the ejector lever being located at a base of the ‘C’ between the sections.

5. A release hook as claimed in claim 4 wherein the sections are bolted together.

6. A release hook as claimed in claim claim 1, wherein the hook includes a catch.

7. A release hook as claimed in claim 6 wherein the catch comprises an elongate member attached to the ejector lever.

8. A release hook as claimed in claim 7 wherein the elongate member and ejector lever are oppositaly opposed on a pivot.

9. A release hook as claimed in claim 1, wherein the gearing means comprises a rack and pinion.

10. A release hook as claimed in claim 9 wherein the pinion is operable via the motor and the rack is located on the ejector lever.

11. A release hook as claimed in claim 1, wherein the gearing means comprises a worn gear.

12. A release hook as claimed in claim 11 wherein the motor turns the worm whose screw thread is located against matching notches on a edge of the ejector lever.

13. A release hook as claimed in claim 8 wherein the gearing means comprises a drive sprocket, driven by the motor to rotate the ejector lever.

14. A release hook as claimed in claim 13 wherein the gearing means rotates the catch with the ejector lever.

15. A release hook as claimed in claim 1, wherein the pad-eye includes an eye-let aperture such that a link may be made between the pad-eye and crane block of a crane.

16. A release hook as claimed in claim 1, wherein the pad-eye comprises a shaft including connection means to a crane block.

17. A release hook as claimed in claim 16 wherein the connection means is a screw thread on the shaft to match a threaded recess in the crane block.

18. A release hook as claimed in claim 1, wherein the pad-eye is swivel mounted on a top of the hook.

19. A release hook a claimed in claim 16, wherein the pad-eye includes a base of greater diameter than the shaft, such that the base is retained between the two sections of the housing while remaining rotatable with respect to the housing.
